(19) United States
(12) Patent Application Publication
(10) Pub. No.: US 2026/0030973 A1
(43) Pub. Date: Jan. 29, 2026

(54) POWER TOOL ADAPTER FOR ESTABLISHING COMMUNICATION BETWEEN POWER TOOL DEVICES AND EXTERNAL DEVICES

(71) Applicant: Milwaukee Electric Tool Corporation, Brookfield, WI (US)

(72) Inventors: Andrew J. Paskov, Brookfield, WI (US); Andrew D. Mansfield, Brookfield, WI (US); Alex D. Garcia, Waukesha, WI (US); Bhagyashree Nanasaheb Shirke, Aliquippa, PA (US)

(21) Appl. No.: 19/277,910

(22) Filed: Jul. 23, 2025

Related U.S. Application Data
(60) Provisional application No. 63/674,871, filed on Jul. 24, 2024.

(51) Int. Cl. G08C 17/02; H01Q 1/22

(52) U.S. Cl. CPC G08C 17/02; H01Q 1/2291

(57) ABSTRACT

An adapter is provided that can include a body including a first interface to couple the adaptor to a first power tool device and a second interface to couple the adapter to a power tool battery pack, a communication port coupled to the body, an antenna coupled to the body, and an electronic controller coupled to the body and in communication with the antenna and the communication port. The electronic controller can include a processor that can be configured to, while coupled via the communication port and a wired connection to a user device, establish communication between a user device and a plurality of power tool devices, receive, via the antenna, tool information from a second power tool device of the plurality of power tool devices, and transmit the tool information to the user device.

### RELATED APPLICATIONS

This application claims priority to U.S. Provisional Application No. 63/674,871, filed on Jul. 24, 2024, which is hereby incorporated by reference in its entirety.

### BACKGROUND

Work tools (e.g., power tools) allow operators to implement various functionalities on many different components (e.g., electrical wires, power cables, sheet metal, etc.). For example, some power tools can include a cutting head that is driven (e.g., hydraulically, or electrically) into a component, such as a power wire, to cut through the component.

### SUMMARY

Some embodiments of the disclosure provide an adapter for power tool systems. The adapter may include a body having a first interface configured to couple the adaptor to a first power tool device. The adapter may include a communication port coupled to the body and an antenna coupled to the body. The adapter may include an electronic controller coupled to the body and in communication with the antenna and the communication port, the electronic controller including a processor and configured to: while coupled via the communication port and a wired connection to a user device, establish communication between a user device and a plurality of power tool devices, receive, via the antenna, tool information from a second power tool device of the plurality of power tool devices, and transmit the tool information to the user device.

Some embodiments of the disclosure provide a communication system. The communication system may include a power tool adapter configured to enable cross-platform communication between a plurality of power tool devices and a user device. The power tool adapter may include a body including a set of electro-mechanical interfaces configured to couple the power tool adaptor to a first power tool device of the plurality of power tool devices and a second power tool device of the plurality of power tool devices. The power tool adapter may include a communication port coupled to the body and an antenna coupled to the body. The power tool adapter may include an electronic controller coupled to the body and in communication with the antenna and the communication port, the electronic controller may include a processor and be configured to: establish communication between the user device and the plurality of power tool devices, where the plurality of power tool devices may include a third power tool device, where the first power tool device and the second power tool device may be compatible with a first power tool platform and the third power tool device may be compatible with a second power tool platform different from the first power tool platform; receive, via the antenna, tool information from the plurality of power tool devices; and transmit the tool information to the user device.

Some embodiments of the disclosure provide a method to communicate tool information. The method may include establishing, using an adapter configured to mechanically couple to a first power tool device and a second power tool device simultaneously, communication with a plurality of power tool devices, where the plurality of power tool devices may include the first power tool device, the second power tool device, and a third power tool device, where the first power tool device and the second power tool device may be compatible with a first power tool platform and the third power tool device is compatible with a second power tool platform different from the first power tool platform. The method may include receiving, using the adapter, tool information from the plurality of power tool devices. The method may include transmitting, using the adapter, the tool information to a user device.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a communication system.

FIG. 2 is another schematic illustration of a communication system.

FIG. 3 shows a perspective view of a power tool adapter.

FIG. 4 shows a block diagram of a power tool.

FIG. 5 shows a block diagram of a power tool battery pack.

FIG. 6 shows a block diagram of a power tool adapter.

FIG. 7 shows a block diagram of a user device.

FIG. 8 shows a flowchart of a process for establishing a communication connection between a user device and power tool devices.

FIG. 9 shows an example graphical user interface including tool information.

### DETAILED DESCRIPTION

As described above, power tools generally can implement various functionalities on different components or work pieces. For example, power tools generally can include an actuator including a moveable component that when moved into contact with the component, implements some kind of functionality on the component. As one example, when the power tool is implemented as a cutting tool, the actuator of the cutting tool can include a cutting head that can, when moved into contact with a work piece (e.g., a wire to be cut) sever the work piece in two. As another example, when the power tool is implemented as a crimping tool, the actuator of the crimping tool can include a crimping head that can, when moved into contact with a work piece (e.g., a wire to be crimped), crimp the work piece (e.g., to create an electrical connection to the wire). As yet another example, when the power tool is a drill-driver, the actuator of the power tool may be a drill chuck configured to accept and retain a drill or driver bit and that is driven by the power tool to rotate the retained bit to, for example, drill a hole in a workpiece (in the case of a drill bit) or drive a fastener into a work piece (in the case of a drive bit).

Some power tools can include an electronic controller that can control various features of the power tool. For example, the electronic controller can drive extension (or rotation or oscillation) of the actuator to implement a functionality on a work piece, or can drive retraction (or rotation in the opposing direction) of the actuator (e.g., after the functionality has been completed or to remove a fastener). In some embodiments, the electronic controller of the power tool can receive data from sensors of the power tool, which can augment the control of the actuator. For example, one sensor can be a trigger sensor that is coupled to the power tool. When a trigger of the power tool is actuated (e.g., depressed by an operator), the trigger sensor may sense and indicate the trigger depression to the electronic controller, which controls the actuator (e.g., to extend, rotate, or oscillate) to implement the functionality of the power tool.

In some cases, multiple different power tools can be located at different positions within a location (e.g., a bounded geographic location, a jobsite, etc.), and it can be desirable to periodically transmit tool information (e.g., a tool identification such as a serial number, a total number of seconds of or during operation of a power tool, a total number of seconds of or during actuation of an actuator of a respective power tool, a total number of driving operations for an actuator of a respective power tool, a location of a respective power tool, a tool identifier including a tool type, etc.) to a wireless communication device (e.g., a smart phone, a laptop, a server, a cellular tower, router, etc.).

Some embodiments described herein provide improved systems and methods to communicate tool information of power tools. For example, some embodiments of the disclosure provide a system that can include a power tool adapter (also referred to herein as an “adapter”), a plurality of power tools, and a user device (e.g., a wireless communication device). As described in greater detail herein, the adapter may facilitate communication between the user device and one or more of the power tools. Accordingly, in some examples, the adapter may act as a gateway device to enable communication between the user device and the power tools. For example, the power tool(s) can communicate tool information to the adapter and the adapter can transmit (or otherwise provide) the tool information to the user device.

In some instances, communication between the user device and the power tools may be cross-platform communication. For instance, each power tool may be compatible with a particular power tool platform, such as, e.g., a particular power tool system, collection, or product line, where each power tool platform may include (or otherwise be implemented via) a set of unique operating parameters or performance characteristics. As one example, each power tool platform may be implemented using different power parameters or systems (e.g., 12 V, 18 V, etc.). For example, a first power tool platform may include power tools that receive and are powered by a first power tool battery pack having a first nominal voltage (e.g., 12 V or another value between 8 and 14 V)), a second power tool platform may include power tools that receive and are powered by a second power tool battery pack having a second nominal voltage that is greater than the first nominal voltage (e.g., 18 V or another value between 16 and 24 V), a third power tool platform may include power tools that receive and are powered by a power tool battery pack having a third nominal voltage that is greater than the second nominal voltage (e.g., 72 V or another value between 30 V and 120 V), and a fourth power tool platform may include corded power tools that are powered via an alternating current (AC) plug that couples the power tool to an AC wall outlet. Additionally, or alternatively, each power tool platform may be implemented using different mechanical parameters (e.g., mechanical coupling system, etc.). For example, a power tool battery pack of a first power tool platform may be mechanically incompatible with or unable to fit or attached to a power tool of a second power tool platform, and vice versa. Accordingly, in some configurations, the adapter may enable power tools from different power tool platforms to communicate (or otherwise provide) tool information to the user device (via the adapter).

In some configurations, the adapter may be mechanically coupled to a first power tool device, a second power tool device, or a combination thereof. For instance, the adapter may be mechanically coupled to a power tool and a battery pack. Accordingly, in some instances, the adapter may be mechanically coupled to two power tools simultaneously (e.g., at the same time). Further, in some configurations, the adapter may also be coupled to the user device while also being coupled to the two power tools. In such configurations, the adapter may be coupled to the user device via a wired communication connection or a wireless communication connection, as described in greater detail herein.

In some embodiments, each component of the power tool system described herein can include one or more antennas (e.g., as part of one or more Bluetooth®, Wi-Fi®), or Zigbee® wireless modules) that are capable of communicating with other devices (e.g., other power tools) according to a Bluetooth®, Wi-Fi®, or Zigbec® wireless protocol. In some examples, the wireless modules and communication protocol are Bluetooth®, which can have advantages as compared to other wireless protocols (e.g., using less power to communicate, providing fast communication speeds, ensuring one-to-one pairing between devices at some times, etc.). Thus, in some cases, the communication established between the adapter, the power tool(s), the user device, or a combination thereof may be Bluetooth® communication.

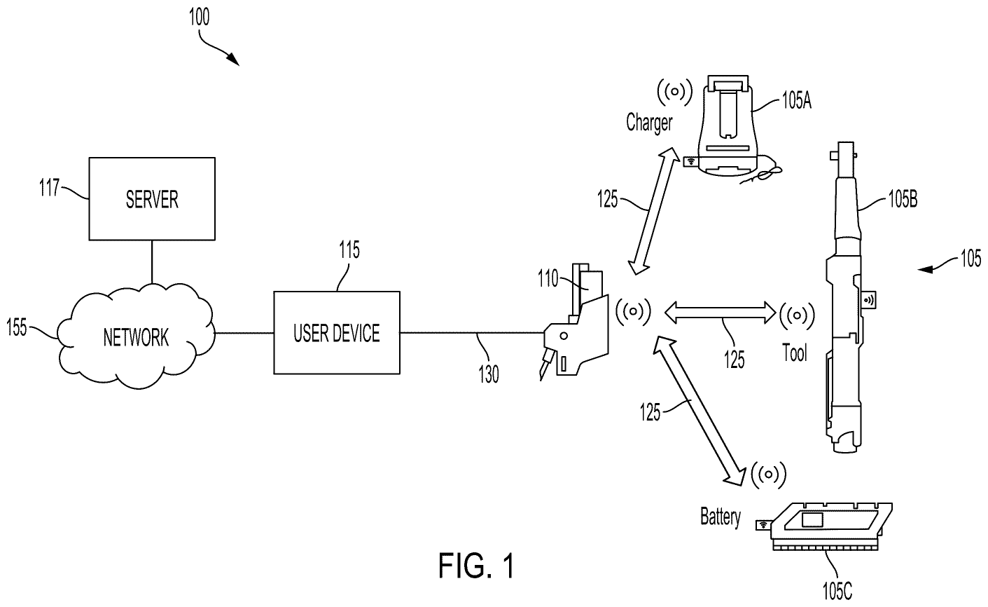

FIG. 1 illustrates a schematic diagram of a communication system 100 according to some configurations. As illustrated in FIG. 1, the communication system 100 may include one or more power tool devices 105, a power tool adapter 110, a user device 115, and a server 117. In some embodiments, the power tool system 100 includes fewer, additional, or different components than illustrated in FIG. 1. Also, in some embodiments, one or more components of the communication system 100 may be combined into a single component (e.g., the user device 115 and the server 117). Alternatively, or in addition, in some embodiments, the functionality (or a portion thereof) described as being performed by a component of the communication system 100 may be distributed among multiple components.

The power tool devices 105 can be implemented in different ways. As used herein, a “power tool device” may include a power tool, a power tool battery pack, a power tool battery pack charger, or a combination thereof. In some cases, each power tool device 105 can be different, can be the same, etc. For example, as illustrated in FIG. 1, the power tool devices 105 may include a power tool battery pack charger 105A, a power tool 105B, and a power tool battery pack 105C. Although only one of each of power tools devices 105A, 105B, and 105C is shown in FIG. 1, in some examples, fewer or additional power tool devices 105A, 105B, and/or 105C are included in the system 100. Each power tool 105B can include an actuator, an electronic controller, a power source interface (e.g., a battery pack interface), etc. In some cases, each power tool 105B can be different, can be the same, etc. For example, one or more of the power tool 105B can be an impact driver, a power drill, a hammer drill, a pipe cutter, a sander, a nailer, a grease gun, a crimper, a radio, a light, a speaker, a location tracking device, any other suitable tool that can send data to another device, etc. In some configurations, two or more power tool devices 105 may be coupled to form a power tool system. For example, when the power tool battery pack 105C is coupled to the power tool 105B, the power tool battery pack 105C and the power tool 105B may form a power tool system. As another example, when the power tool battery pack 105C is coupled to the power tool battery pack charger 105A, the power tool battery pack 105C and the power tool battery pack charger 105A may form a power tool system.

Regardless of the configuration, each power tool device 105, can be configured to directly communicate with the power tool adapter 110 (e.g., over a wireless or wired communication channel). In the illustrated example of FIG. 1, the power tool devices 105 can directly communicate with the power tool adapter 110 using one or more wireless communication channels 125. In some configurations, each power tool device 105 can directly communicate with the power tool adapter 110 according to a wireless protocol, which can be a Bluetooth® wireless protocol. Alternatively, or in addition, in some configurations, each power tool device 105 can directly communicate with each other (e.g., over a wireless or wired communication channel).

In some embodiments, each power tool 105B can be a motorized power tool, or a non-motorized power tool. In some cases, each motorized power tool can include a moveable component and an actuator (e.g., a motor) that can move (e.g., translate, rotate, reciprocate, oscillate, etc.) the moveable component to implement a functionality on a workpiece. For example, a motorized power tool can be a drill, an impact driver, a crimper, a cutter, etc. In some configurations, each non-motorized power tool can lack an actuator, a moveable component, etc., and thus can lack the ability to implement a functionality on a workpiece. For example, a non-motorized power tool can be a radio, a light, a speaker, a power supply (e.g., a portable power supply), a location tracking device, etc.

In some embodiments, the power tool adapter 110 can function as a dongle (e.g., in a “dongle mode”), as described in greater detail herein. For instance, the power tool adapter 110 may be connected to and used with the user device 115 to provide additional functionality to the user device 115, such as, e.g., functionality that enables communication of tool information as described herein. For example, in some configurations, the power tool adapter 110 may function as a bridge (or an in-between wireless connection) to the power tool devices 105 and the user device 115 such that the power tool devices 105 may communicate and exchange data (e.g., tool information) with the user device 115. Accordingly, in some configurations, the power tool adapter 110 may be communicatively coupled to the user device 115. For instance, as illustrated in the example of FIG. 1, the power tool adapter 110 and the user device 115 may be communicatively coupled via a wired communication channel (or connection) 130.

The user device 115 may be, for example, a laptop computer, a tablet computer, a smartphone, a cellphone, or another electronic device capable of communicating with the power tool adapter 110 and providing a user interface. The user device 115 includes a communication interface that is compatible with the power tool adapter 110. The communication interface of the user device 115 may include a USB port, a micro USB port, another suitable power and/or data port, a wireless communication module (e.g., a Bluetooth® module), or a combination thereof. The user device 115, therefore, grants a user access to data related to the power tool device(s) 105 (e.g., tool information), and provides a user interface such that the user can interact with an electronic controller of the power tool device(s) 105, as described in greater detail herein.

In addition, as illustrated in FIG. 1, the user device 115 can also share the tool information obtained from the power tool device 105 with the server 117. The server 117 may be used to store the data (e.g., the tool information) obtained from the user device 115, provide additional functionality and services to the user, or a combination thereof. In one embodiment, storing the tool information on the server 117 allows a user to access the information from a plurality of different locations (e.g., via the user device 115 or another user device (not shown) coupled to the network 155). In another embodiment, the server 117 may collect information from various users regarding their power tool devices and provide statistics or statistical measures to the user based on information obtained from the different power tools. For example, the server 117 may provide statistics regarding the experienced efficiency of the power tool device 105, typical usage of the power tool device 105, and other relevant characteristics and/or measures of the power tool device 105.

Although not illustrated, the server 117 may include similar components as the user device 115 (as described herein), such as electronic processor (for example, a microprocessor, an application-specific integrated circuit (ASIC), or another suitable electronic device), a memory (for example, a non-transitory, computer-readable storage medium), a communication interface, such as a transceiver, for communicating over the communication network 155 and, optionally, one or more additional communication networks or connections, and one or more human machine interfaces. For example, to communicate with the user device 115, the server 117 may store a browser application or a dedicated software application executable by an electronic processor. The communication system 100 is described herein as implementing a communication connection via the power tool adapter 110 such that the user device 115 may communicate with one or more of the power tool devices 105 (e.g., to exchange tool information, operation data, firmware updates, etc.) through the server 117, the user device 115, or a combination thereof.

In some configurations, the server 117 may include one or more server processors and memories in a localized unit or distributed across multiple units in one or more locations (e.g., implementing a cloud-based system). In some configurations, the server 117 can store tool data for various power tool devices 105, including, e.g., the tool information, which can include configuration data for the power tools (e.g., to configure operational parameters of the power tool), usage data for the power tools (e.g., an amount of time available for operation for each power tool), maintenance data for the power tools (e.g. a log of prior maintenance, suggestions for future maintenance, etc., for each power tool), operator (and owner information) for the power tools, location data for each power tool (e.g., for inventory management and tracking), etc. The server 117 can also store battery pack data for various battery packs including battery pack information.

As illustrated in FIG. 1, the user device 115 and the server 117 communicate over one or more wired or wireless communication networks 155. Portions of the communication networks 155 may be implemented using a wide area network, such as the Internet, a local area network, such as Bluetooth™ network or Wi-Fi, and combinations or derivatives thereof. The network 155 may include one or more local area networks and/or one or more wide area networks coupled together, which may include various wired and wireless connections and interfaces, intermediate devices, access points, hubs, routers, modems, and the like. For example, the network 155 may include a local area WiFi network including a WiFi router as well as a wide area network, such as the Internet, connected to the WiFi router via a modem, and the intervening connections and devices typical of such networks. The network 155 may further include respective local area networks proximate to each of the server 150 and the user device 115.

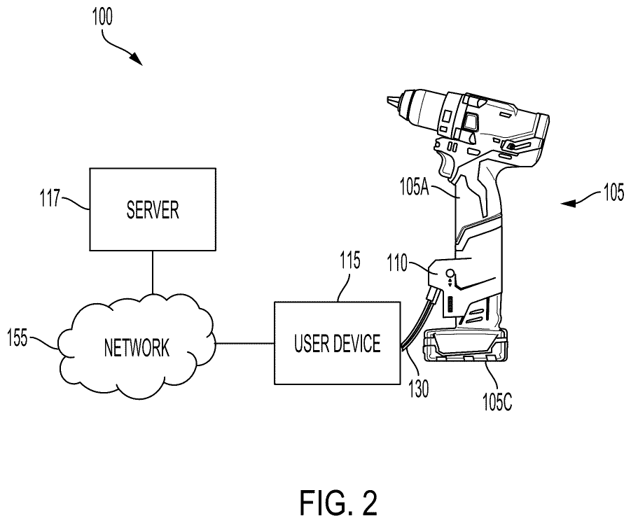

FIG. 2 illustrates another schematic diagram of the communication system 100 according to some configurations. In the example of FIG. 2, the power tool adapter 110 is physically (or electro-mechanically) coupled to the power tool 105B and the power tool battery pack 105C. As described in greater detail herein, the power tool adapter 110 may be physically coupled to the power tool 105B and the power tool battery pack 105C via a set of electro-mechanical interfaces. In the example of FIG. 2, the power tool adapter 110 may be communicatively coupled to the user device 115. In some instances, the power tool adapter 110 may be communicatively coupled to the user device 115 via a wired or wireless communication connection (or channel), as described in greater detail herein.

Accordingly, in some configurations, as illustrated in FIG. 1, the power tool adapter 110 may communicate with the power tool devices 105 via a wireless communication connection (e.g., the wireless communication channels 125 of FIG. 1). Alternatively, or in addition, in some configurations, as illustrated in FIG. 2, the power tool adapter 110 may communicate with the power tool devices 105 via a wired communication connection (e.g., a set of electro-mechanical interfaces coupling the adapter 110 to the power tool devices 105).

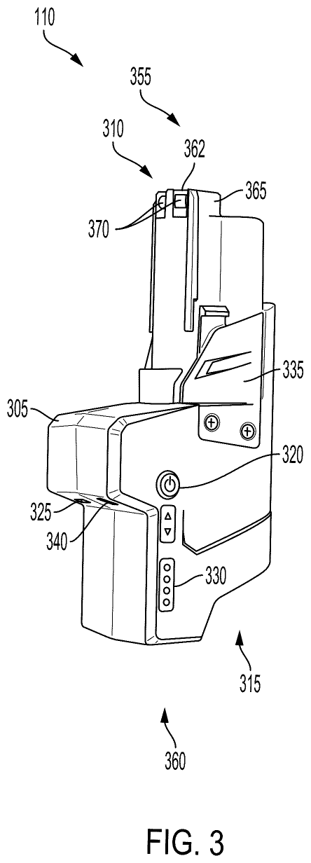

FIG. 3 illustrates an example front perspective view of the power tool adapter 110 of the communication system 100 according to some configurations. As illustrated in FIGS. 1-2, the power tool adapter 110 may be coupled to one or more power tool devices 105 and the user device 115. In general, the power tool adapter 110 creates a communication path between the power tool devices 105 and the user device 115. As illustrated in FIG. 1, when the power tool adapter 110 is operated in a dongle mode (e.g., to enable a wireless connection between the user device 115 and the power tool devices 105), the power tool adapter 110 may be communicatively coupled to the user device 115 via a wired communication connection (e.g., the wired communication connection 103 of FIG. 1) and the power tool adapter 110 may be communicatively coupled to the power tool device(s) 105 via a wireless communication connection (e.g., the wireless communication connections 125 of FIG. 1). Alternatively, or in addition, as illustrated in FIG. 2, in some configurations, the power tool adapter 110 may be configured to be coupled to the power tool device(s) 105 (e.g., the power tool 105B and the power tool battery pack 105C, as illustrated in FIG. 2). The power tool adapter 110 may be coupled to various types of power tool devices 105, including, e.g., the power tool battery pack charger 105A, the power tool 105B, the power tool battery pack 105C, or a combination thereof.

The power tool adapter 110 couples to different power tool devices 105 to export information from the power tool devices 105 and import information into the power tool devices 105. The power tool adapter 110, for example, obtains and exports tool usage data, maintenance data, mode information, drive device information, and the like from the power tool device(s) 105 (e.g., tool information). The power tool adapter 110 also imports (i.e., provides) information into the power tool devices 105 such as, for example, configuration data, operation thresholds, maintenance thresholds, mode configurations, programming for a respective power tool device, firmware updates for a respective power tool device, and the like. In general, the power tool adapter 110 creates a communication path between the power tool devices 105 and the user device 115.

As illustrated in FIG. 3, the power tool adapter 110 may include a housing 305, a tool-side interface 310, a battery-side interface 315, a power switch 320, a communication port 325, a power indicator 330, a latching mechanism 335, and a power port 340. The housing 305 may include a top (first) side 355, a bottom (second) side 360 opposite the top side 355, and sidewalls connecting the top side 355 and the bottom side 360. As illustrated in FIG. 3, the tool-side interface 310 may be located on the top side 355, while the battery-side interface 315 may be located on the bottom side 360 of the power tool adapter 110. The tool-side interface 310 may be configured to couple to the power tool 105B. The battery-side interface 315 may be configured to couple to the battery pack 105C. In some configurations, the tool-side interface 310, the battery-side interface 315, or a combination there of may be electro-mechanical interfaces. As used herein, an electro-mechanical interface may refer to an interface that provides an electrical coupling and a mechanical coupling such that when components are coupled via the electro-mechanical interface, the components are both electrically and mechanically coupled.

The tool-side interface 310 may include a tool-side connector 362. The tool-side connector 362 may include a raised portion 365 and two contacts 370. The raised portion 365 may protrude from the top side 355 of the housing 305. The two contacts 370 are partially covered by the raised portion 365. The two contacts 370 and the raised portion 365 form female contacts configured to receive corresponding male blade terminals of an interface of the power tool device 105 (e.g., the power tool 105B). The tool-side connector 362 can also couple to a battery pack charger (e.g., the power tool battery pack charger 105A of FIG. 1). Accordingly, the tool-side connector 362 may also be referred to as a charger-side connector and a tool/charger-side connector. The power tool adapter 110 may exchange information with the power tool battery pack charger 105A. The tool-side connector 362 may receive male blades from the power tool battery pack charger 105A and may provide electrical communication with the user device 115. Example power tool battery pack charger data that may be exported from the power tool battery pack charger 105A via the power tool adapter 110 may include charging history data and maintenance data. Charging history data can include the number, types, and identities of battery packs charged, as well as the charging current provided to various battery packs. Additionally, a user via the user device 115 may communicate to the power tool battery pack charger 105A via the power tool adapter 110 to add, delete, or modify charging schemes, firmware, various settings and parameters, etc. For instance, a user can update charge current levels, timing for switching between current levels, various thresholds used to determine charge current levels, add charging schemes for new battery packs, etc. Although the tool-side connector 362 is illustrated to include two contacts 370, in some embodiments, the tool-side connector 362 may include additional, fewer, or different contacts.

The power tool adapter 110 may be removable and interchangeably connected to various power tool devices 105 through the latching mechanism 335. The latching mechanism 335 releasably secures the power tool adapter 110 to the power tool device 105 (e.g., the power tool device 105B). In some configurations, the latching mechanism 335 may be removable from the housing 305 of the power tool adapter 110.

The tool-side connector 362 of the power tool adapter 110 may replicate a power interface included in the power tool battery pack 105C such that the power tool adapter 110 is compatible with the power tool 105B. Therefore, the connection between the power tool 105B and the power tool adapter 110 replicates the connection between the power tool 105B and the corresponding power tool battery pack 105C such that the connections are intuitive to a user.

The battery-side interface 315 may include a battery-side connector. The battery-side connector may include a terminal block and a set of male blade terminals extending beyond the housing 305. The terminal block and the set of male blade terminals may be recessed in a cavity of the battery-side interface 315. The cavity may be shaped such that the contours of the power tool battery pack 105C match the general shape of the cavity.

As illustrated in FIG. 3, the power switch 320, the communication port 325, the power indicator 330, and the power port 340 may be positioned on a sidewall of the housing 305. In the illustrated embodiment, the power switch 320 and the power indicator 330 are positioned on the same sidewall, such that when the power tool adapter 110 is coupled to the power tool device 105, the power switch 320 and the power indicator 330 both face the side of the power tool device 105. The communication port 325 and the power port 340 may be positioned in a front sidewall of the housing 305, such that when the power tool adapter 110 is coupled to the power tool device 105, the communication port 325 and the power port 340 both face the front side of the power tool device 105.

In some configurations, the communication port 325 may facilitate the communication and exchange of data with the user device 115. In some configurations, communication between the power tool adapter 110 and the user device 115 (e.g., via the communication port 325) may be implemented using hardware-driven serial communications. Alternatively, or in addition, in some configurations, communication between the power tool adapter 110 and the user device 115 may be implemented through a wireless communication connection (or channel). In some configurations, the communication port 325 may be a universal serial bus (USB) port. Alternatively, or in addition, the communication port 325 may include another type of communication port. For example, the communication port 325 may include an RS-232 port, a microUSB port, a proprietary port, etc. Furthermore, the power tool adapter 110 may include more than one communication port 325 such that the power tool adapter 110 may be compatible with different user devices 115 that may include different types of communication ports or connectors.

The power port 340 may facilitate the exchange of power from an external power source to the power tool adapter 110. For instance, the power port 340 may receive a power cable or cord and receive, via the power cable or cord, power from a power source coupled to the power cable or cord. Accordingly, in some configurations, the power port 340 may facilitate charging of the power tool adapter 110.

In some examples, the power tool adapter 110 may provide power to the power tool device 105B such as, e.g., when the power tool device 105B is coupled to the power tool adapter 110 and the power tool adapter 110 is coupled to an external power source (e.g., via a power cable or cord coupled to the power port 340). Accordingly, in some configurations, the power tool adapter 110 may provide power to (or otherwise charge) a power tool device 105B, including, e.g., when the power tool device 105B is not coupled to a corresponding power tool battery pack 105C. As such, the power tool adapter 110 may facilitate the transfer of power received via the power port 340 from an external device to the power tool device 105B.

The power indicator 330 may provide an indication of a state of charge (or charge level) of the power tool adapter 110. In some instances, as illustrated in FIG. 3, the power indicator 330 may include a series of lighting elements (e.g., LEDs), where each lighting element represents a state of charge for the power tool adapter 110, thereby providing a visual indication to a user of the state of charge of the power tool adapter 110.

The power switch 320 may be a push-button switch that turns the power tool adapter 110 on and off. When the power tool adapter 110 is on, communication between the user device 115 and the power tool device(s) 105 may be enabled. When the power tool adapter 110 is off, communications between the power tool device(s) 105 and the user device 105 may cease. In some embodiments, the power switch 320 also includes a lighting element that lights up when the power tool adapter 110 is powered and lights off when the power tool adapter 110 is not powered, thereby providing a visual indication to the user of the power status of the power tool adapter 110. In some embodiments, when the power tool adapter 110 is coupled to both the power tool 105B and the power tool battery pack 105C, the power tool 105B and the power tool battery pack 105C can communicate with each other and perform general operations (i.e., the power tool battery pack 105C can transmit electrical power to the power tool 105B to drive a motor thereof) regardless of whether the power tool adapter 110 is on or off. In other embodiments, however, the power tool 105B and the power tool battery pack 105C can only communicate with each other and perform general operations when the power tool adapter 110 is either on or removed such that the power tool battery pack 105C is connected directly with the power tool 105B.

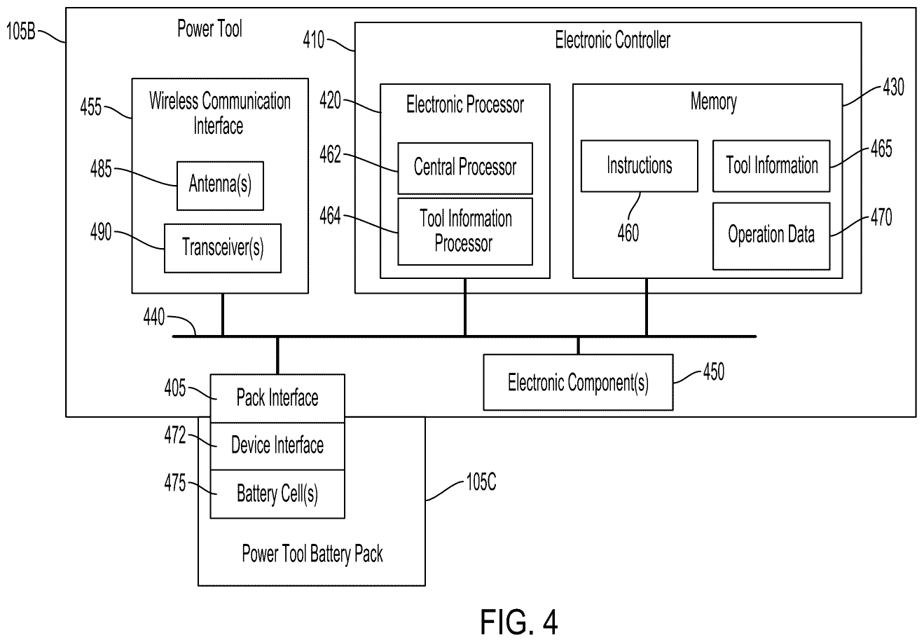

FIG. 4 illustrates a block diagram of the power tool 105B included in the communication system 100 of FIGS. 1 and 2 according to some configurations. The power tool 105B includes a pack interface 405, an electronic controller 410 with an electronic processor 420 and a memory 430, a communication bus 440, one or more electronic components 450, and a wireless communication interface 455. The electronic processor 420, the memory 430, the electronic component(s) 450, and the wireless communication interface 455 may communicate over one or more control and/or data buses (for example, the communication bus 440).

The memory 430 may include read-only memory (ROM), random access memory (RAM), other non-transitory computer-readable media, or a combination thereof. The memory 430 may include instructions 460 for the electronic processor 420 to execute. Alternatively, or in addition, as illustrated in FIG. 4, the memory 430 may include tool information 465 and operation data 470.

The tool information 465 and the operation data 470 may be specific to the power tool 105B. As described herein, tool information may include tool usage data, maintenance data, mode information, drive device information, and the like. For example, the tool information 465 may include, e.g., a tool identification such as a serial number for the power tool 105B, a total number of seconds of or during operation of the power tool 105B, a total number of seconds of or during actuation of an actuator of the power tool 105B, a total number of driving operations for an actuator of the power tool 105B, a location of the power tool 105B, a tool identifier including a tool type of the power tool 105B, etc.

The operation data 470 may include configuration data, operation thresholds, maintenance thresholds, mode configurations, programming, tool firmware, etc. The operation data 470 may include one or more operating parameters or settings that control operation of the power tool 105B. For example, the operation data 470 may include a speed parameter, a torque parameter, one or more parameter thresholds (e.g., an electric current threshold or a temperature threshold indicating when to stop a motor, change a motor speed, or perform another other action), etc. In some configurations, the operation data 470 may be included as part of the instructions 460.

The electronic processor 420 may be configured to communicate with the memory 430 to store data and retrieve stored data. The electronic processor 420 may be configured to receive the instructions 460 and data from the memory 430 and execute, among other things, the instructions 460. In some examples, through execution of the instructions 460 by the electronic processor 420, the electronic controller 410 may perform one or more of the methods described herein. For example, the instructions 460 may include software executable by the electronic processor 420 to enable the electronic controller 410 to, among other things, implement the various functions of the electronic controller 410 described herein, including collecting and tracking tool information and providing tool information to an external device (e.g., the power tool adapter 110), as described in greater detail herein. In some examples, the electronic processor 420 includes one or more electronic processors. For example, as illustrated, the electronic processor 420 may include a central processor 462 and a tool information processor 464. In other examples, the functions of the processors 462 and 464 are combined into a single processor or further distributed among additional processors. In some examples, the tool information processor 464 may execute instructions 460 to perform tool information collection and transmission, as described herein. In other words, the tool information processor 464 may serve as a dedicated processor to collect and track tool information and provide tool information to external devices, as described herein. In such examples, the central processor 462 may perform other control for the power tool 105B, such as, for example, enabling and disabling a motor, output device, charging circuit, etc.

The power tool 105B includes the pack interface 405 for selective attachment and detachment to a device interface 472 of the power tool battery pack 105C and for selective attachment and detachment from the tool-side interface 310 of the adapter 110. The pack interface 405 may include one or more power terminals and, in some cases, one or more communication terminals that interface with respective power and/or communication terminals of the device interface 472 and of the tool-side interface 310. The power tool battery pack 105C includes the device interface 472 for selective attachment and detachment from the pack interface 405 of the power tool 105B and for selective attachment and detachment from the battery-side interface 315 of the adapter 110. The power tool battery pack 105C may include one or more battery cells 475.

The electronic components 450 may vary depending on a type of the power tool device 102. As one example, the electronic components 450 may include a switching circuit and a motor. The switching circuit may include a one or more power switching elements (e.g., field effect transistors (FETs), bipolar junction transistors (BJTs), or the like), which may be arranged as a switch bridge. The electronic controller 410 may control the switching circuit to provide power from the power tool battery pack 105C to the motor to drive the motor. The motor may be a permanent magnet brushless motor, a brushed motor, or another type of motor. As another example, the electronic components 450 may include a switching circuit and an output circuit. The switching circuit may include a one or more power switching elements (e.g., field effect transistors (FETs), bipolar junction transistors (BJTs), or the like), which may be arranged as a switch bridge. The electronic controller 410 may control the switching circuit to provide power from the power tool battery pack 105C to the output circuit to drive the output circuit. The output circuit may include a power-driven output element, for example, one or more of a work light, a radio circuit, a speaker, a microphone, a sensor circuit, a display, among other elements.

The wireless communication interface 455 may enable the power tool 105B to communicate with an external device (e.g., the power tool adapter 110) via a wireless communication connection (or channel) (e.g., the wireless communication connection(s) 125 of FIG. 1). While the wireless communication interface 455 is described herein as enabling the power tool 105B to wirelessly communicate with the power tool adapter 110, the wireless communication interface 455 may be configured to enable the power tool 105B to wirelessly communicate with another external device, such as, e.g., another power tool device 105.

In some configurations, the wireless communication interface 455 may include a transceiver 485 (e.g., a radio transceiver) and an antenna 490 to send and receive wireless messages to and from the power tool adapter 110. The wireless communication interface 455 may be used, for example, when the power tool adapter 110 functions in a dongle mode, as described in greater detail herein. In some configurations, the wireless communication interface 455 may include its own electronic controller to effect wireless communications between the power tool adapter 110 and the power tool 105B. For example, an electronic controller associated with the wireless communication interface 455 may buffer incoming and/or outgoing data, communicate with the electronic controller 410, and determine the communication protocol and/or settings to use in wireless communications.

In some configurations, the wireless communication interface 455 may be a Bluetooth® communication interface (i.e., facilitate Bluetooth® communication). For instance, the Bluetooth® interface may communicate with the power tool adapter 110 employing the Bluetooth® protocol. Therefore, in some configurations, the power tool adapter 110 and the power tool 105B may be in proximity of each other during the exchange of data. In other embodiments, the wireless communication interface 455 communicates using other protocols (e.g., Wi-Fi, cellular protocols, etc.) over a different type of wireless network. For example, the wireless communication interface 455 may be configured to communicate via Wi-Fi through a wide area network, such as the Internet or a local area network, or to communicate through a piconet (e.g., using infrared or NFC communications). The communication via the wireless communication interface 455 may be encrypted to protect the data exchanged between the power tool adapter 110 and the power tool 105B from third parties.

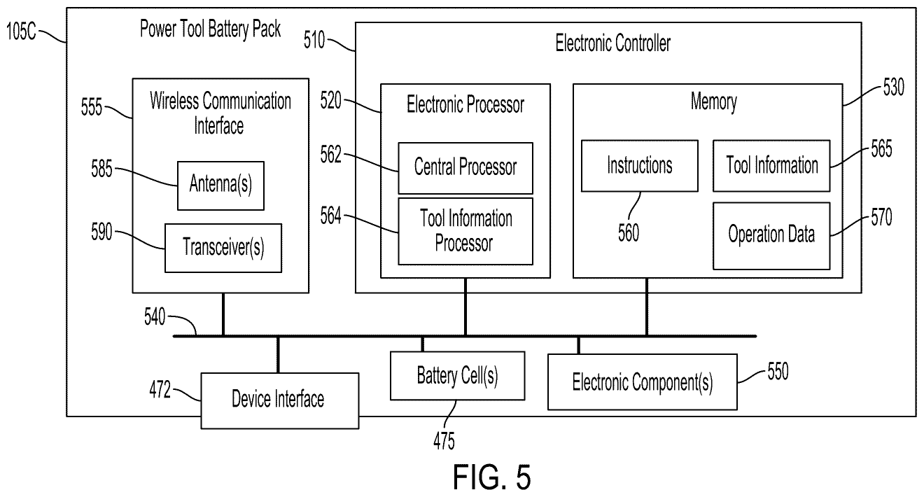

FIG. 5 illustrates a block diagram of the power tool battery pack 105C included in the communication system 100 of FIGS. 1 and 2 according to some configurations. The power tool battery pack 105C includes the device interface 472, the battery cells 475, an electronic controller 510, with an electronic processor 520 and a memory 530, a communication bus 540, one or more electronic components 550, and a wireless communication interface 555. The electronic processor 520, the memory 530, the electronic component(s) 550, and the wireless communication interface 555 may communicate over one or more control and/or data buses (for example, the communication bus 540).

The memory 530 may include read-only memory (ROM), random access memory (RAM), other non-transitory computer-readable media, or a combination thereof. The memory 530 may include instructions 560 for the electronic processor 520 to execute. Alternatively, or in addition, as illustrated in FIG. 5, the memory 530 may include tool information 565 and operation data 570.

The tool information 565 and the operation data 570 may be specific to the power tool battery pack 105C. As described herein, tool information may include tool usage data, maintenance data, mode information, charge cycle information, and the like. For example, the tool information 465 may include, e.g., a tool identification such as a serial number for the power tool battery pack 105C, a total number of seconds of or during operation of the power tool battery pack 105C, a total number of seconds of or cycles of charging performed with the power tool battery pack 105C, a total number of charging cycles or operations of the power tool battery pack 105C, a location of the power tool battery pack 105C, a tool identifier including a battery pack type of the power tool battery pack 105C, etc.

The operation data 570 may include configuration data, operation thresholds, maintenance thresholds, mode configurations, programming, tool firmware, etc. The operation data 570 may include one or more operating parameters or settings that control operation of the power tool battery pack 105C. For example, the operation data 570 may include a charging parameter, one or more parameter thresholds (e.g., an electric current threshold or a temperature threshold indicating when to stop a charging cycle, change a charging parameter, or perform another other action), etc. In some configurations, the operation data 570 may be included as part of the instructions 560.

The electronic processor 520 may be configured to communicate with the memory 530 to store data and retrieve stored data. The electronic processor 520 may be configured to receive the instructions 560 and data from the memory 530 and execute, among other things, the instructions 560. In some examples, through execution of the instructions 560 by the electronic processor 520, the electronic controller 510 may perform one or more of the methods described herein. For example, the instructions 560 may include software executable by the electronic processor 520 to enable the electronic controller 510 to, among other things, implement the various functions of the electronic controller 510 described herein, including collecting and tracking tool information and providing tool information to an external device (e.g., the power tool adapter 110), as described in greater detail herein. In some examples, the electronic processor 520 includes one or more electronic processors. For example, as illustrated, the electronic processor 520 may include a central processor 562 and a tool information processor 564. In other examples, the functions of the processors 562 and 564 are combined into a single processor or further distributed among additional processors. In some examples, the tool information processor 564 may execute instructions 560 to perform tool information collection and transmission, as described herein. In other words, the tool information processor 564 may serve as a dedicated processor to collect and track tool information and provide tool information to external devices, as described herein. In such examples, the central processor 562 may perform other control for the power tool battery pack 105C, such as, e.g., regulating charging and discharging of the battery cells 475.

The electronic components 550 may vary depending on a type of the power tool battery pack 105C. In some configurations, the electronic components 550 may include or be similar to the electronic components 450 as described herein with respect to FIG. 4. In some configurations, the electronic components 550 may include one or more components of the power tool battery pack 105C, such as, e.g., the wireless communication interface 555, the battery cells 475, etc.

The wireless communication interface 555 may enable the power tool battery pack 105C to communicate with an external device (e.g., the power tool adapter 110) via a wireless communication connection (or channel) (e.g., the wireless communication connection(s) 125 of FIG. 1). While the wireless communication interface 555 is described herein as enabling the power tool battery pack 105C to wirelessly communicate with the power tool adapter 110, the wireless communication interface 455 may be configured to enable the power tool battery pack 105C to wirelessly communicate with another external device, such as, e.g., another power tool device 105.

In some configurations, the wireless communication interface 555 may include a transceiver 585 (e.g., a radio transceiver) and an antenna 590 to send and receive wireless messages to and from the power tool adapter 110. The wireless communication interface 555 may be used, for example, when the power tool adapter 110 functions in a dongle mode, as described in greater detail herein. In some configurations, the wireless communication interface 555 may include its own electronic controller to effect wireless communications between the power tool adapter 110 and the power tool battery pack 105C. For example, an electronic controller associated with the wireless communication interface 555 may buffer incoming and/or outgoing data, communicate with the electronic controller 510, and determine the communication protocol and/or settings to use in wireless communications.

In some configurations, the wireless communication interface 555 may be a Bluetooth® communication interface (i.e., facilitate Bluetooth® communication). For instance, the Bluetooth® interface may communicate with the power tool adapter 110 employing the Bluetooth® protocol. Therefore, in some configurations, the power tool adapter 110 and the power tool battery pack 105C may be in proximity of each other during the exchange of data. In other embodiments, the wireless communication interface 555 communicates using other protocols (e.g., Wi-Fi, cellular protocols, etc.) over a different type of wireless network. For example, the wireless communication interface 555 may be configured to communicate via Wi-Fi through a wide area network, such as the Internet or a local area network, or to communicate through a piconet (e.g., using infrared or NFC communications). The communication via the wireless communication interface 555 may be encrypted to protect the data exchanged between the power tool adapter 110 and the power tool battery pack 105C from third parties.

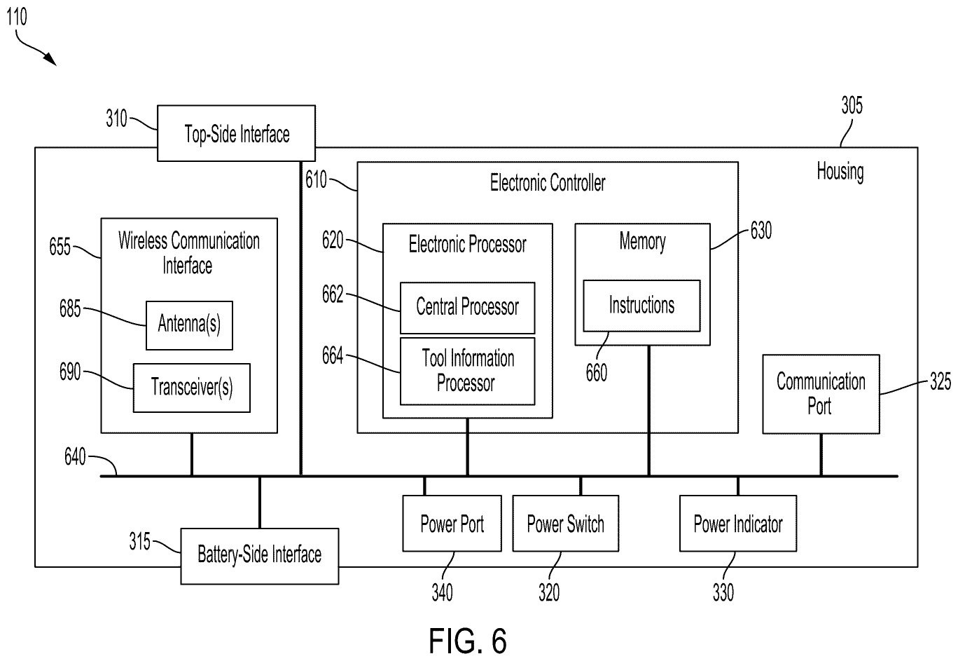

FIG. 6 illustrates a block diagram of the power tool adapter 110 included in the communication system 100 of FIGS. 1 and 2 according to some configurations. In the illustrated example, the power tool adapter 110 may include the housing 305, the tool-side interface 310, the battery-side interface 315, the power switch 320, the communication port 325, the power indicator 330, and the power port 340 as described herein with respect to FIG. 3. As illustrated, the power tool adapter 110 may include an electronic controller 610, with an electronic processor 620 and a memory 630, a communication bus 640, and a wireless communication interface 655. The tool-side interface 310, the battery-side interface 315, the power switch 320, the communication port 325, the power indicator 330, the power port 340, the electronic processor 620, the memory 630, and the wireless communication interface 655 may communicate over one or more control and/or data buses (for example, the communication bus 640).

The memory 630 may include read-only memory (ROM), random access memory (RAM), other non-transitory computer-readable media, or a combination thereof. The memory 630 may include instructions 660 for the electronic processor 620 to execute.

The electronic processor 620 may be configured to communicate with the memory 630 to store data and retrieve stored data. The electronic processor 620 may be configured to receive the instructions 660 and data from the memory 630 and execute, among other things, the instructions 660. In some examples, through execution of the instructions 660 by the electronic processor 620, the electronic controller 610 may perform one or more of the methods described herein. For example, the instructions 660 may include software executable by the electronic processor 620 to enable the electronic controller 610 to, among other things, implement the various functions of the electronic controller 610 described herein, including facilitating communication between the user device 115 and one or more of the power tool devices 105, as described in greater detail herein. In some examples, the electronic controller 610 may receive tool information from one or more of the power tool devices 105 (via the communication port 325 or the wireless communication interface 655) and transmitting (or otherwise providing) the tool information to the user device 115. Alternatively, or in addition, in some examples, the electronic controller 610 may receive (e.g., from the user device 115) operation data (e.g., the operation data 470 or the operation data 570) and transmit the operation data to one or more of the power tool devices 105. In some configurations, the operation data may include one or more software updates (e.g., tool firmware updates). Accordingly, in some examples, the electronic controller 610 may receive (e.g., from the user device 115) a firmware update and transmit the firmware update to one or more of the power tool devices 105.

In some examples, the electronic processor 620 includes one or more electronic processors. For example, as illustrated, the electronic processor 620 may include a central processor 662 and a communication processor 664. In other examples, the functions of the processors 662 and 664 are combined into a single processor or further distributed among additional processors. In some examples, the communication processor 664 may execute instructions 660 to facilitate communication between the user device 115 and one or more of the power tool devices 105, as described herein. In other words, the communication processor 664 may serve as a dedicated processor to facilitate communication between external devices, as described herein. In such examples, the central processor 662 may perform other control for the power tool adapter 110.

The wireless communication interface 655 may enable the power tool adapter 110 to communicate with an external device (e.g., the user device 115 or one or more of the power tool devices 105) via a wireless communication connection (or channel) (e.g., the wireless communication connection(s) 125 of FIG. 1). While the wireless communication interface 655 is described herein as enabling the power tool adapter 110 to wirelessly communicate with one or more of the power tool devices 105, the wireless communication interface 655 may be configured to enable the power tool adapter 110 to wirelessly communicate with another external device, such as, e.g., the user device 115.

In some configurations, the wireless communication interface 655 may include an antenna 685 and a transceiver 690 (e.g., a radio transceiver) to send and receive wireless messages to and from the power tool device(s) 105. In some configurations, the wireless communication interface 655 may be used, for example, when the power tool adapter 110 functions in a dongle mode, as described in greater detail herein. For instance, when the power tool adapter 110 functions in a dongle mode, the power tool adapter 110 may communicate with the power tool device(s) 105 wirelessly (via, e.g., the wireless communication connection(s) 125 of FIG. 1). Additionally, when the power tool adapter 110 functions in the dongle mode, the power tool adapter 110 may communicate with the user device 115 via the communication port 325 (e.g., via a wired communication connection, such as the wired communication connection 130 of FIGS. 1 and 2). However, in some configurations, the power tool adapter 110 may communicate with the user device 115 via the wireless communication interface 655 such that a wireless communication connection (or channel) is established between the power tool adapter 110 and the user device 115. In some instances, the power tool adapter 110 may communicate with the user device 115 via the wireless communication interface 655 when the power tool adapter 110 is functioning in a dongle mode.

In some configurations, the wireless communication interface 655 may include its own electronic controller to effect wireless communications between the power tool device(s) 105. For example, an electronic controller associated with the wireless communication interface 655 may buffer incoming and/or outgoing data, communicate with the electronic controller 610, and determine the communication protocol and/or settings to use in wireless communications.

In some configurations, the wireless communication interface 655 may be a Bluetooth® communication interface (i.e., facilitate Bluetooth® communication). For instance, the Bluetooth® interface may communicate with the power tool device(s) 105, the user device 115, or a combination thereof employing the Bluetooth® protocol. Therefore, in some configurations, the power tool adapter 110 and the power tool device(s) 105, the user device 115, or a combination thereof may be in proximity of each other during the exchange of data. In other embodiments, the wireless communication interface 655 communicates using other protocols (e.g., Wi-Fi, cellular protocols, etc.) over a different type of wireless network. For example, the wireless communication interface 655 may be configured to communicate via Wi-Fi through a wide area network, such as the Internet or a local area network, or to communicate through a piconet (e.g., using infrared or NFC communications). The communication via the wireless communication interface 655 may be encrypted to protect the data exchanged between the power tool adapter 110 and the power tool device(s) 105, the user device 115, or a combination thereof from third parties.

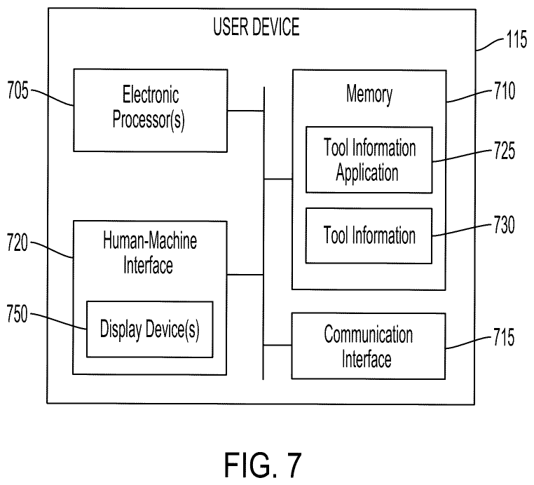

FIG. 7 illustrates a schematic diagram of the user device 115 of FIG. 1 according to some configurations. The user device 115 may be a computing device and may include a desktop computer, a terminal, a workstation, a laptop computer, a tablet computer, a smart watch or other wearable, a smart television or whiteboard, or the like. As illustrated in FIG. 7, the user device 115 includes an electronic processor 705 (for example, a microprocessor, an application-specific integrated circuit (ASIC), or another suitable electronic device), a memory 710 (for example, a non-transitory, computer-readable medium), a communication interface 715, and a human-machine interface 720. The electronic processor 705, the memory 710, the communication interface 715, and the human-machine interface (HMI) 720 communicate wirelessly, over one or more communication lines or buses, or a combination thereof. It should be understood that the user device 115 may include additional components than those illustrated in FIG. 7 in various configurations and may perform additional functionality than the functionality described herein. For example, in some embodiments, the functionality described herein as being performed by the user device 115 may be distributed among servers or devices (including as part of services offered through a cloud service), may be performed by one or more servers 117, or a combination thereof.

The communication interface 715 allows the user device 115 to communicate with devices external to the user device 115. For example, as illustrated in FIG. 7, the user device 115 may communicate with the server 117, the power tool adapter 110, the one or more power tool devices 105, or a combination thereof through the communication interface 715. The communication interface 715 may include a port for receiving a wired connection (e.g., the wired communication connection 130 of FIGS. 1 and 2) to an external device (for example, a universal serial bus (“USB”) cable and the like), a transceiver for establishing a wireless connection to an external device (for example, over one or more communication networks 155, such as the Internet, local area network, a wide area network, and the like), or a combination thereof.

The electronic processor 705 is configured to access and execute computer-readable instructions (“software”) stored in the memory 710. The software may include firmware, one or more applications, program data, filters, rules, one or more program modules, and other executable instructions. For example, the software may include instructions and associated data for performing a set of functions, including the methods described herein.

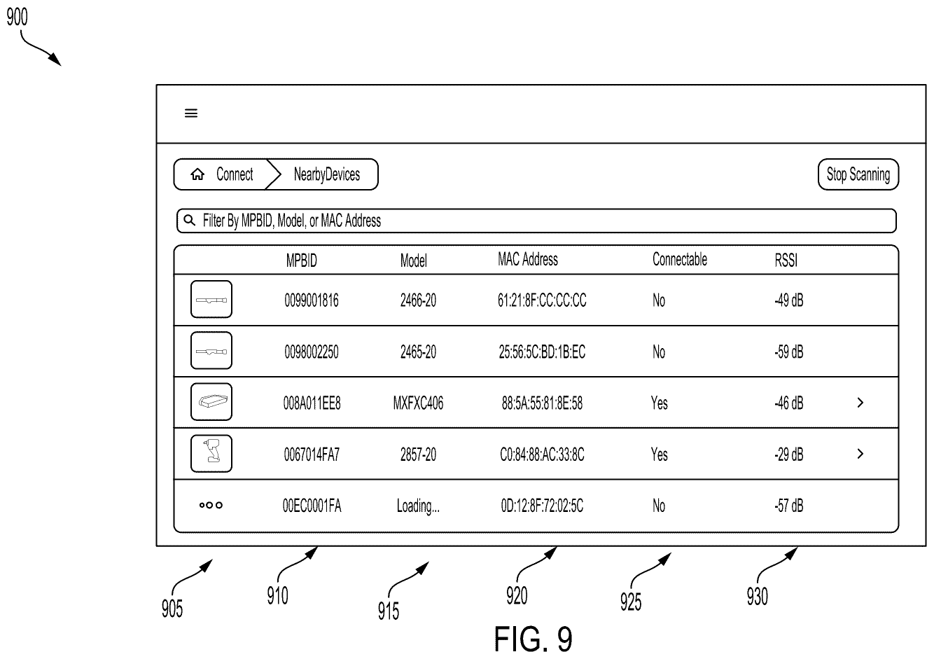

As illustrated in FIG. 7, the memory 710 may store a tool information application 725 (also referred to herein as “the application 725”). The application 725 is a software application executable by the electronic processor 705. As described in more detail below, the electronic processor 705 may execute the application 725 to retrieve tool information, provide configuration or operation data to one or more of the power tool devices 105, including, e.g., a tool firmware update, etc. As also illustrated in FIG. 7, the memory 710 may also store tool information 730. The tool information 730 stored in the memory 710 may include tool information received (or otherwise retrieved from) one or more of the power tool devices 105, such as, e.g., via the power tool adapter 110, as described in greater detail herein. In some configurations, the electronic processor 705 may execute the application 725 in order to generate and provide a graphical user interface (“GUI”) including the tool information 730, as described in greater detail herein (with respect to FIG. 9).

As illustrated in FIG. 7, in some configurations, the user device 115 may include the HMI 720 for interacting with a user. The HMI 720 may include one or more input devices, one or more output devices, or a combination thereof. Accordingly, in some configurations, the HMI 720 allows a user to interact with (e.g., provide input to and receive output from) the user device 115. For example, the HMI 720 may include a keyboard, a cursor-control device (e.g., a mouse), a touch screen, a scroll ball, a mechanical button, a display device (e.g., a liquid crystal display (LCD)), a printer, a speaker, a microphone, another type of input device, another type of output device, or a combination thereof. As illustrated in FIG. 7, in some configurations, the HMI 720 includes a display device 750. The display device 750 may be included in the same housing as the user device 115 or may communicate with the user device 115 over one or more wired or wireless connections. For example, in some configurations, the display device 750 is a touchscreen included in a laptop computer or a tablet computer. In other configurations, the display device 750 is a monitor, a television, or a projector coupled to a terminal, desktop computer, or the like via one or more cables.

A user may use the user device 115 to interact with, e.g., the application 725 such that the user may interact with one or more of the power tool devices 105 via a connection provided by the power tool adapter 110. As one example, a user may use the user device 115 to interact with the tool information 730. As another example, the user may use the user device 115 to configure one or more of the power tool devices 105.

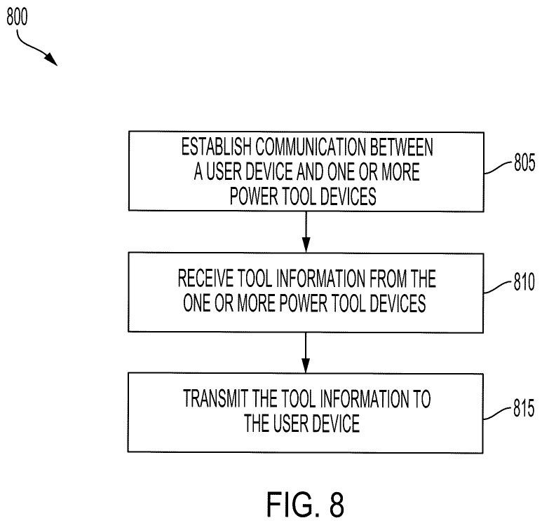

FIG. 8 illustrates a flowchart of a process 800 for implementing a communication connection between the user device 115 and one or more of the power tool devices 105 using the power tool adapter 110 operating in a dongle mode (as illustrated in FIG. 1), which can be implemented using any of the systems described herein (e.g., the communication system 100). However, in some embodiments, the process 800 is implemented by another system having additional components, fewer components, alternative components, etc. In some specific cases, the process 800 can be implemented using a power tool device 105. Additionally, although the blocks of the process 800 are illustrated in a particular order, in some embodiments, one or more of the blocks can be executed partially or entirely in parallel, can be executed in a different order than illustrated in FIG. 8, or can be bypassed. For illustration purposes, the process 800 is generally described as being implemented by the power tool adapter 110 in the context of the communication system 100 in FIG. 1. However, in other embodiments, other devices or components of the communication system 100, or other components or devices of other systems, can implement the process 800.

In block 805, the process 800 can include the power tool adapter 110 (e.g., the electronic controller 610 thereof) establishing communication between the user device 115 and one or more of the power tool devices 105. As described in greater detail herein, in some configurations, the power tool adapter 110 may establish communication between the user device 115 by establishing a wired communication connection (e.g., the wired communication connection 130), via the communication port 325, with the user device 115. In some examples, establishing the wired communication connection may include the devices receiving a physical connection by the wired communication connection 130 (e.g., a USB® cable) to one another, a supply of power from the user device 115 to the adapter 110 via the wired communication connection 130, an exchange of identifiers (e.g., of the respective devices) via the wired communication connection 130, an exchange of communication parameters (e.g., timing information) via the wired communication connection 130, and/or performance of other steps in a handshaking processes. Additionally, in some configurations, the power tool adapter 110 may establish communication with the power tool device(s) 105 by establishing a wireless communication connection (e.g., the wireless communication connections 125), via the wireless communication interface 655 (e.g., the antenna(s) 685, the transceiver(s) 690, or a combination thereof), with the power tool device(s) 105 (e.g., the wireless communication interface 455 of the power tool device(s) 105). In some examples, establishing the wireless communication connection may include forming of a communication link according to a wireless communication protocol used by the adapter 110 and the one or more power tool devices 105 (e.g., Bluetooth®, Wi-Fi®, Zigbee®, etc.). For example, the devices may exchange identifiers (e.g., of the respective devices), may exchange wireless communication parameters (e.g., timing information), and/or perform other steps in a handshaking processes.

In block 810, the process 800 can include the power tool adapter 110 (e.g., the electronic controller 610 thereof) receiving tool information (e.g., the tool information 465, 565) from the power tool device(s) 105. In some configurations, the power tool adapter 110 may receive the tool information wirelessly via, e.g., a wireless communication connection (e.g., the wireless communication connection(s) 125 of FIG. 1). In some instances, the power tool adapter 110 may receive the tool information via the antenna 685 of the wireless communication interface 655. In some configurations, the power tool adapter 110 may receive tool information from a single power tool device 105. Alternatively, or in addition, in some configurations, the power tool adapter 110 may receive tool information from multiple power tool devices 105. The multiple power tool devices 105 may be of the same type (e.g., multiple chargers 105A, multiple power tools 105B, or multiple power tool battery packs 105C), may be of different types (at least two selected from a group of chargers 105A, tools 105B, and battery packs 105C), or a combination of same and different types.

As noted herein, in some instances of block 810, the power tool adapter 110 may receive tool information from power tool devices 105 included in different power tool platforms (or tool systems). For example, the power tool adapter 110 may receive tool information from a first power tool device of a first platform and from a second power tool device of a second power tool platform. In some examples, the power tool adapter 110 is configured to in couple to a power tool and power tool battery pack of the first platform (e.g., with reference to FIGS. 3-6, via tool-side interface 310 coupling to the pack interface 405 and via the battery-side interface 315 coupling to the device interface 472), and is incompatible with the power tool and power tool battery pack of the second platform (e.g., the tool-side interface 310 cannot electrically and/or mechanically couple to the pack interface 405 and/or the battery-side interface 315 cannot electrically and/or mechanically couple to the device interface 472). For example, the first platform may include a stem-style power tool battery pack that is inserted into a receptacle of the power tool in a direction of a longitudinal axis of the stem (see, e.g., FIG. 2), while the second platform may include a slide-on style power tool battery pack that slides to engage an interface of the power tool (see, e.g., battery pack 105C of FIG. 1).

In block 815, the process 800 can include the power tool adapter 110 (e.g., the electronic controller 610 thereof) transmitting the tool information (e.g., the tool information 465, 565) to the user device 115. In some configurations, the power tool adapter 110 may transmit the tool information to the user device 115 via the wired communication connection formed between the user device 115 and the power tool adapter 110 (e.g., the communication port 325).

Responsive to receiving the tool information, the user device 115 may compile the tool information from across multiple power tool devices 105 (including, e.g., across multiple platforms) and generate a GUI including the tool information. As noted herein, in some configurations, the user device 115 (e.g., the electronic processor 705 executing the application 725) may generate and provide a GUI including the tool information 730.

For example, FIG. 9 illustrates an example GUI 900 including the tool information according to some configurations. As illustrated in FIG. 9, the GUI 900 may include a listing 905 of power tool devices 105, where tool information associated with each power tool device 105 included in the listing 905 is correspondingly included in the GUI 900. For example, the GUI 900 may include corresponding tool identifications (represented in FIG. 9 by reference numeral 910), tool models (represented in FIG. 9 by reference numeral 915), MAC addresses (represented in FIG. 9 by reference numeral 920), a connection ability or status (represented in FIG. 9 by reference numeral 925), and a received signal strength indicator (represented in FIG. 9 by reference numeral 930) indicating a strength of a wireless signal between the adapter 110 and the power tool device 105 (e.g., indicated in decibels or another unit of measurement or scale). The GUI 900 also includes a search field to enable a user to enter a tool identifier, model type, or MAC address to filter the power tool devices listed in the listing 905. The GUI 900 also includes a scan button (e.g., “Connect” or “NearbyDevices” element on the GUI 900) to initiate a scan to populate the listing 905 with power tool devices 105 within wireless communication range of the adapter 110 coupled to the user device 115. The GUI 900 also includes a stop scanning button to cease or disable a scan previously initiated by the user device (e.g., in response to actuation of the scan button on the GUI 900).

In some examples, in place of or in addition to block 810 and 815, the process 800 includes the adapter receiving information from the user device 115 for providing to the one or more power tool devices 105. For example, the information may include configuration data, operation thresholds, maintenance thresholds, mode configurations, programming for a respective power tool device, firmware updates for a respective power tool device, and the like. The adapter 110 may then transmit to the power tool devices 105 the information to the one or more power tool devices 105. The power tool device(s) 105 receiving the information may then apply the information to update the power tool device 105 (e.g., update one or more of a configuration, an operation threshold, a maintenance threshold, a mode configuration, programming, or firmware of the power tool device 105).

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. An adapter for power tool systems, the adapter comprising:
a body comprising a first interface configured to couple the adaptor to a first power tool device;
a communication port coupled to the body;
an antenna coupled to the body; and
an electronic controller coupled to the body and in communication with the antenna and the communication port, the electronic controller including a processor and configured to:
while coupled via the communication port and a wired connection to a user device,
establish communication between a user device and a plurality of power tool devices,
receive, via the antenna, tool information from a second power tool device of the plurality of power tool devices, and
transmit the tool information to the user device.

2. The adapter of claim 1, further comprising a second interface configured to couple the adapter to a power tool battery pack, wherein the first power tool device and the power tool battery pack are of a first power tool platform such that the first power tool device is configured to receive the power tool battery pack and to be powered by the power tool battery pack, and the second power tool device is compatible with a second power tool system and is incompatible with the power tool battery pack.

3. The adapter of claim 2, wherein the first power tool device and the power tool battery pack operate at a first nominal voltage and the second power tool device operates at a second nominal voltage that is different than the first nominal voltage.

4. The adapter of claim 1, wherein the electronic controller is configured to:
receive, via the antenna, additional tool information from a third power tool device of the plurality of power tool devices; and
transmit the tool information to the user device.

5. The adapter of claim 1, wherein the electronic controller is configured to receive additional power tool device information from at least one selected from a group of the first power tool device via the first interface or a power tool battery pack coupled to the adapter via a second interface of the body.

6. The adapter of claim 5, wherein the antenna is configured to establish a wireless communication connection with the user device, and, wherein the electronic controller is configured to transmit, via the antenna, the additional power tool device information to the user device via the wireless communication connection.

7. The adapter of claim 6, wherein the wireless communication connection is a Bluetooth communication connection.

8. The adapter of claim 1, wherein the electronic controller is configured to:
receive a firmware update for the second power tool device; and
transmit the firmware update to the first power tool device, wherein, upon receipt of the firmware update, the first power tool device implements the firmware update.

9. The adapter of claim 8, wherein the electronic controller is configured to transmit the firmware update to the first power tool device via a plurality of battery terminals of the first power tool device coupled to the first interface of the body of the adapter.

10. The adapter of claim 8, wherein the electronic controller is configured to receive, via the communication port, the firmware update from the user device.

11. The adapter of claim 1, further comprising a second interface configured to couple the adapter to a power tool battery pack, wherein the first power tool device is a power tool, wherein the second interface is configured to receive power from the power tool battery pack, and wherein the first interface is configured to provide the power to the power tool.

12. A communication system, the communication system including:
a power tool adapter configured to enable cross-platform communication between a plurality of power tool devices and a user device, the power tool adapter including:
a body including a set of electro-mechanical interfaces configured to couple the power tool adaptor to a first power tool device of the plurality of power tool devices and a second power tool device of the plurality of power tool devices;
a communication port coupled to the body;
an antenna coupled to the body; and
an electronic controller coupled to the body and in communication with the antenna and the communication port, the electronic controller including a processor and configured to:
establish communication between the user device and the plurality of power tool devices, wherein the plurality of power tool devices includes a third power tool device, wherein the first power tool device and the second power tool device are compatible with a first power tool platform and the third power tool device is compatible with a second power tool platform different from the first power tool platform;
receive, via the antenna, tool information from the plurality of power tool devices; and
transmit the tool information to the user device.

13. The communication system of claim 12, wherein the power tool adapter is communicatively coupled to the user device via the communication port and the power tool adapter is communicatively coupled to the plurality of power tool devices through the antenna, wherein the communication port is configured to establish a wired communication connection and the antenna is configured to establish a wireless communication connection.

14. The communication system of claim 12, wherein the tool information includes at least one of:
a tool identification of a respective power tool device;
a total amount of time during operation of a respective power tool device;
a total amount of time during actuation of an actuator of a respective power tool device;
a total number of driving operations for an actuator of the respective power tool device;
a location of a respective power tool device; or
an amount of time available for operation for a respective power tool device relative to a battery level for the respective power tool device.

15. The communication system of claim 12, wherein the electronic controller is configured to:
receive a firmware update for the second power tool device; and
transmit the firmware update to the second power tool device, wherein, upon receipt of the firmware update, the second power tool device implements the firmware update.

16. The communication system of claim 15, wherein the electronic controller is configured to transmit the firmware update to the second power tool device via a plurality of battery terminals coupled to the body of the power tool adapter when the second power tool device is coupled to the body of the power tool adapter via a first mechanical interface of the set of mechanical interfaces.

17. A method to communicate tool information, the method comprising:
establishing, using an adapter configured to mechanically couple to a first power tool device and a second power tool device simultaneously, communication with a plurality of power tool devices, wherein the plurality of power tool devices includes the first power tool device, the second power tool device, and a third power tool device, wherein the first power tool device and the second power tool device are compatible with a first power tool platform and the third power tool device is compatible with a second power tool platform different from the first power tool platform;
receiving, using the adapter, tool information from the plurality of power tool devices; and
transmitting, using the adapter, the tool information to a user device.

18. The method of claim 17, wherein receiving the tool information includes receiving, using an antenna of the adapter, the tool information wirelessly from the plurality of power tool devices.

19. The method of claim 17, wherein transmitting the tool information includes transmitting, using a communication port of the adapter, the tool information to the user device via a data cable communicatively coupling the user device and the communication port of the adapter.

20. The method of claim 17, wherein transmitting the tool information includes transmitting, using an antenna of the adapter, the tool information wirelessly to the user device.
